(19) United States
(12) Patent Application Publication
(10) Pub. No.: US 2015/0287976 A1
(43) Pub. Date: Oct. 8, 2015

(54) RECHARGEABLE BATTERY HAVING PROTECTIVE CIRCUIT MODULE

(71) Applicant: SAMSUNG SDI CO., LTD., Yongin-si (KR)

(72) Inventor: Bum-Kuk CHOI, Yongin-si (KR)

(21) Appl. No.: 14/600,878

(22) Filed: Jan. 20, 2015

(30) Foreign Application Priority Data
Apr. 4, 2014 (KR) 10-2014-0040810

(51) Int. Cl. H01M 2/34; H01M 2/04; H01M 2/22; H01M 10/052

(52) U.S. Cl. CPC H01M 2/34; H01M 10/052; H01M 2/04; H01M 2/0404; H01M 2/043; H01M 2/22; H01M 2200/00; H01M 2220/30; H01M 2220/20

(57) ABSTRACT

A rechargeable battery including an electrode assembly, the electrode assembly including a first electrode, a second electrode, and a separator interposed therebetween; a receiving case having a space in which the electrode assembly is accommodated; a cap plate coupled with the receiving case, the cap plate having a seating groove therein; and a protective circuit module in the seating groove, wherein the cap plate includes a base and a sidewall, the sidewall protruding from a side end of the base to form the seating groove.

### CROSS-REFERENCE TO RELATED APPLICATION

Korean Patent Application No. 10-2014-0040810, filed on Apr. 4, 2014, in the Korean Intellectual Property Office, and entitled: “Rechargeable Battery Having Protective Circuit Module,” is incorporated by reference herein in its entirety.

### BACKGROUND

1. Field

Embodiments relate to a rechargeable battery having a protective circuit module.

2. Description of the Related Art

A rechargeable battery is a battery that may be repeatedly charged and discharged, unlike a primary battery that is incapable of being recharged. A rechargeable battery of a low capacity may be used for a small portable electronic device such as a mobile phone, a laptop computer, or a camcorder, and a large capacity battery may be used as a power source for driving a motor of a hybrid vehicle, etc.

A rechargeable battery may include, e.g., a nickel-cadmium (Ni—Cd) battery, a nickel-hydrogen (Ni-MH) battery, a lithium (Li) battery, or a lithium ion (Li-ion) rechargeable battery. For example, the lithium ion secondary battery may have a higher operation voltage (by about three times) than either of the nickel-cadmium battery or the nickel-hydrogen battery, which may mainly be used as a portable electric equipment power source. Also, the lithium ion rechargeable battery has been considered in terms of high energy density per unit weight.

The rechargeable battery may use a lithium-based oxide as a positive electrode active material, and a carbonaceous as a negative electrode active material. In general, the rechargeable battery may be classified into, e.g., a liquid electrolyte battery and a polymer electrolyte battery, according to a kind of an electrolyte. The battery using the liquid electrolyte may be referred to as a lithium ion battery, and the battery using the polymer electrolyte may be referred to as a lithium polymer battery.

The above information disclosed in this Background section is only for enhancement of understanding of the background of the described technology and therefore it may contain information that does not form the prior art that is already known in this country to a person of ordinary skill in the art.

### SUMMARY

Embodiments are directed to a rechargeable battery having a protective circuit module.

The embodiments may be realized by providing a rechargeable battery including an electrode assembly, the electrode assembly including a first electrode, a second electrode, and a separator interposed therebetween; a receiving case having a space in which the electrode assembly is accommodated; a cap plate coupled with the receiving case, the cap plate having a seating groove therein; and a protective circuit module in the seating groove, wherein the cap plate includes a base and a sidewall, the sidewall protruding from a side end of the base to form the seating groove.

The receiving case may include a step groove therein, the sidewall of the cap plate being in the step groove.

The protective circuit module may further include a connection tab fixed to the base of the cap plate.

The connection tab may be fixed to the base by welding.

The connection tab may be fixed to the base by a screw.

The cap plate may further include an upper plate, the upper plate contacting an upper end of the sidewall and extending in a lengthwise direction of the cap plate.

One end of the base in the lengthwise direction of the cap plate and one end of the upper plate in the lengthwise direction of the cap plate may be connected to each other via the sidewall.

The protective circuit module may include a connection protrusion, the connection protrusion protruding toward the base, an upper portion of the protective circuit module may include an aperture therein, and the connection protrusion may be fixed to the cap plate by welding through the aperture.

The protective circuit module may include a plurality of outer terminals thereon.

The rechargeable battery may further include a top cover, the top cover covering the protective circuit module and being coupled with the receiving case.

The top cover may include fixing protrusions thereon, and an outer surface of the receiving case may include fixing grooves therein, the fixing protrusions being coupled with the fixing grooves.

The rechargeable battery may further include a top cover, the top cover covering the protective circuit module and being fitted into the seating groove.

The sidewall of the cap plate may include fixing protrusions thereon, and the top cover may include fixing grooves therein, the fixing protrusions being coupled with the fixing grooves.

The sidewall of the cap plate may include fixing grooves therein, and the top cover may include fixing protrusions thereon, the fixing protrusions being coupled with the fixing grooves.

The rechargeable battery may further include an insulation case between the electrode assembly and the cap plate.

### BRIEF DESCRIPTION OF THE DRAWINGS

Features will be apparent to those of skill in the art by describing in detail exemplary embodiments with reference to the attached drawings in which:

FIG. 1 illustrates a perspective view of a rechargeable battery according to an embodiment.

FIG. 2 illustrates an exploded perspective view of a rechargeable battery according to an embodiment.

FIG. 3 illustrates a cross-sectional view taken along line of FIG. 1.

FIG. 4 illustrates an exploded perspective view of a cap plate and a protective circuit module according to an embodiment.

FIG. 5 illustrates a cross-sectional view of a state in which members shown in FIG. 4 are coupled with each other.

FIG. 6 illustrates a cross-sectional view of a portion of a rechargeable battery according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

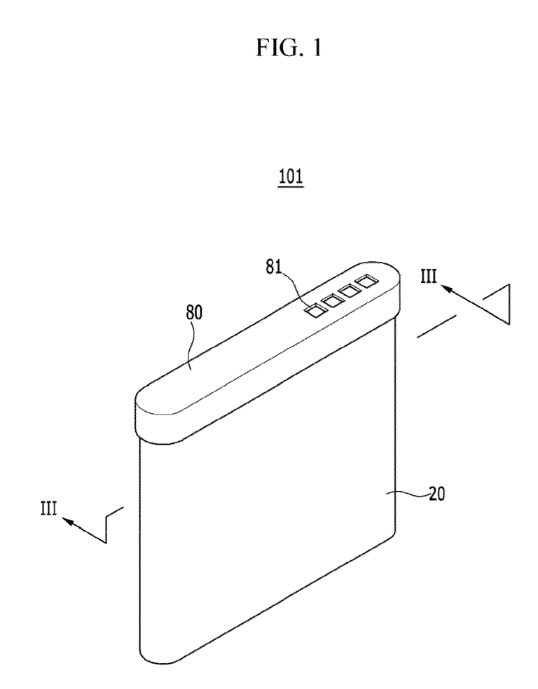

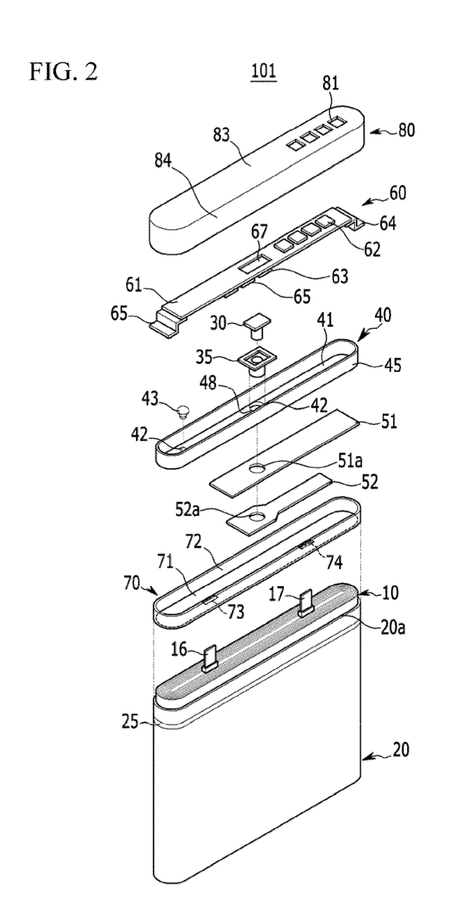

FIG. 1 illustrates a perspective view of a rechargeable battery according to an embodiment, and FIG. 2 illustrates an exploded perspective view of a rechargeable battery according to an embodiment.

Referring to FIG. 1 and FIG. 2, the rechargeable battery 101 according to the present embodiment may include, e.g., an electrode assembly 10, a receiving case 20, an insulation case 70, a cap plate 40, and a protective circuit module 60. Hereinafter, the embodiments are described a square or prismatic shape battery only by way of example. The embodiments may be applied to various rechargeable batteries, e.g., a pouch battery, a lithium polymer battery, or the like.

The electrode assembly 10 may include a positive electrode 11 (e.g., a first electrode), a negative electrode 12 (e.g., a second electrode), and a separator 13 between the positive electrode 11 and the negative electrode 12. The positive electrode 11 may have a long strip shape and may include a positive electrode coating region (at which a positive electrode active material layer is formed) and a positive electrode uncoated region (at which an active material is not coated). The positive electrode uncoated region may be at one end relative to a length direction of the positive electrode 11.

The negative electrode 12 may have a long strip shape, and may include a negative electrode coating region (at which a negative electrode active material layer is formed) and a negative electrode uncoated region (at which an active material is not coated). The negative electrode uncoated region may be at one end relative a length direction of the negative electrode 12. The positive electrode 11 and the negative electrode 12 may be spiral-wound in a jelly roll structure having the separator 13, e.g., an insulator, interposed therebetween.

In an implementation, the electrode assembly may be formed in a sequentially stacked structure so that the separator is interposed between the positive electrode and the negative electrode.

A positive electrode tab 16 (e.g., a first tab) may be fixedly installed in or on the positive electrode 11, and a negative electrode tab 17 (e.g., a second tab) may be fixedly installed in or on the negative electrode 12. The positive electrode tab 16 and the negative electrode tab 17 may be disposed so as to be in parallel with a winding shaft or axis of the electrode assembly 10, and may protrude from an upper end of the electrode assembly 10.

The positive electrode tab 16 may be made of an electrically conductive material, e.g., nickel or aluminum, and may be electrically connected to the cap plate 40. The negative electrode tab 17 may be made of an electric electrically conductive material, e.g., copper or nickel, and may be electrically connected to an inner terminal 30.

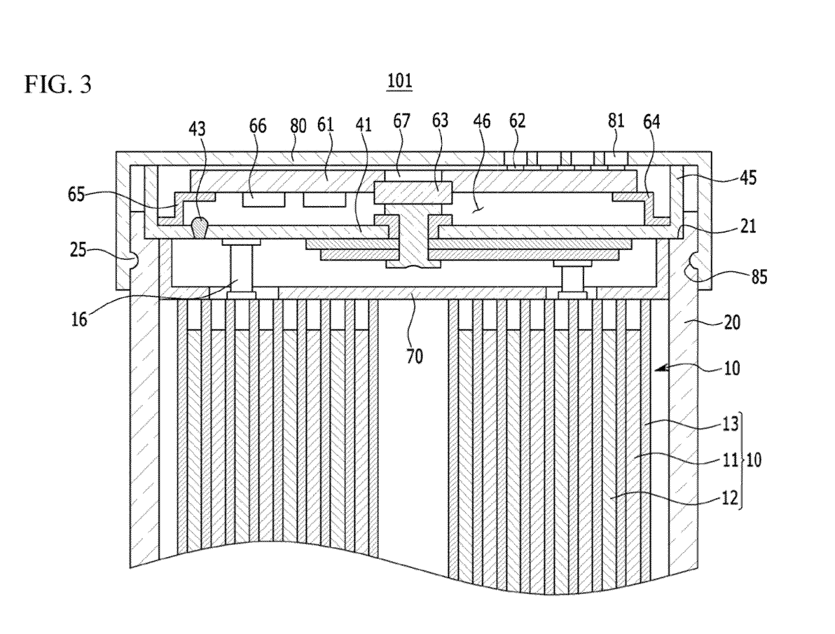

Referring to FIG. 2 and FIG. 3, the receiving case 20 may have a box or prismatic shape having an inner space, and may have an opening 20a at an upper end thereof to receive or accommodate the electrode assembly 10 therethrough or therein. The receiving case 20 may provide a space in which the electrode assembly 10 and an electrolyte solution are received, and may be electrically connected to the positive electrode tab 16. The receiving case 20 may be made of, e.g., aluminum or an aluminum alloy, and may be manufactured by, e.g., a deep drawing method.

A step groove 21 may be provided at an upper part of the receiving case 20, and a sidewall 45 of the cap plate 40 may be inserted into or coupled with the step groove 21. The step groove 21 may be on an inner side wall surface of the receiving case 20, and may contact a bottom end of the sidewall 45. As a result, the step groove 21 may help support the cap plate 40.

The insulation case 70 may be between the electrode assembly 10 and the cap plate 40. The insulation case 70 may include a bottom 71 and a supporting rib 72 that protrudes from the bottom and that is insertedly installed into the receiving case 20. The insulation case 70 may include a first tab hole 73 (through which the positive electrode tab 16 penetrates) and a second tab hole 74 (through which the negative electrode tab 17 penetrates).

The inner terminal 30 may be electrically connected to the negative electrode tab 17, and may be fixedly installed in the cap plate 40. The inner terminal 30 may be inserted into a terminal hole 48 at a center of the cap plate 40. The inner terminal 30 may be inserted into the terminal hole 48 with an insulation gasket 35, and the insulation gasket 35 may electrically insulate the inner terminal 30 and the cap plate 40 from each other while surrounding a circumference of the inner terminal 30.

A connection plate 52 may be below the cap plate 40, and the negative electrode tab 17 may be fixed to the connection plate 52 by welding. The connection plate 52 may have a plate shape and may be disposed in parallel with the cap plate 40. A hole 52a (into which the inner terminal 30 is inserted) may be formed in the connection plate 52.

An insulation plate 51 may be between the cap plate 40 and the connection plate 52 so as to insulate the cap plate 40 from the connection plate 52. The insulation plate 51 may have a plate shape, may be electrically insulating, and may be disposed in parallel with the cap plate 40. A hole 51a (through which the inner terminal 30 penetrates) may be formed in the insulation plate 51.

The inner terminal 30 may be installed so as to penetrate the cap plate 40, the insulation plate 51, and the connection plate 52 and thus, the inner terminal 30 may be electrically connected to the negative electrode 12 via the connection plate 52 and the negative electrode tab 17.

The cap plate 40 may be coupled with the receiving case 20 at the opening 20a of the receiving case 20 to seal the receiving case 20. The cap plate 40 may be made of an electrically conductive metal material, e.g., aluminum or an aluminum alloy. The positive electrode tab 16 may be bonded to the bottom of the cap plate 40 by, e.g., welding, and the cap plate 40 may have the same polarity as the positive electrode tab 16, e.g., may be positively charged.

An electrolyte solution injection hole 42 may be formed in the cap plate 40 as a passage for injecting the electrolyte solution into the receiving case 20. In an implementation, a cap 43 may be installed so as to be inserted into the electrolyte solution injection hole 42 to close the electrolyte solution injection hole 42. Further, the terminal hole 48 (into which the inner terminal 30 is inserted) may be formed at the center of the cap plate 40.

The cap plate 40 may include a base 41 and the sidewall 45. The sidewall 45 may protrude from a side end of the base 41. The base 41 may have a plate shape, and the sidewall 45 may extend, e.g., orthogonally and along a circumference of the base 41. As a result, the cap plate 40 may be provided with a seating groove 46 therein and surrounded by the sidewall 45 (and having one side defined by the base 41).

A protective circuit module 60 (that controls charging and discharging operations of the rechargeable battery) may be insertedly installed into the seating groove 46. The protective circuit module 60 may include a substrate 61 and a plurality of circuit elements 65 on the substrate 61. In an implementation, the protective circuit module 60 may include lead tabs 64 and 65 attached to or coupled with the cap plate 40. In an implementation, the lead tabs 64 and 65 may be fixed on the base 41 by the welding. Accordingly, the protective circuit module 60 may be connected to or coupled with the cap plate 40 via the lead tabs 64 and 65.

In an implementation, the protective circuit module 60 may include a terminal connection member 63 to be attached to or coupled with the inner terminal 30. The substrate 61 may include an aperture 67 in an upper portion of or overlying the terminal connection member 63 to expose a top surface of the terminal connection member 63. Thus, an apparatus for welding may be inserted into the aperture 67 to contact or otherwise act on the terminal connection member 63 to thereby fix the terminal connection member 63 to the inner terminal 30 or cap plate 40 by the welding.

In an implementation, outer terminals 62, e.g., four outer terminals 62, may be installed in or on the protective circuit module 30. For example, the outer terminals 62 may serve as a sensing terminal that is capable of transferring current to the outside and measuring the current and the voltage of the rechargeable battery.

A top cover 80 (surrounding the protective circuit module 60) may be fitted into or onto or coupled with the receiving case 20. The top cover 80 may include a supporting plate 83 and a supporting wall 84. The supporting wall 84 may protrude downwardly, e.g., orthogonally, from a side end of the supporting plate 83.

The top cover 80 may have fixing protrusions 85 that are fitted into fixing grooves 25 on an external circumferential surface of the receiving case 20. The fixing protrusions 85 may protrude at or from an inner side of the supporting wall 84.

The top cover 80 may cover an upper portion of the cap plate 40, and the protective circuit module 60 may be between the cap plate 40 and the upper cover 80. A plurality of terminal holes 81 may be formed in the top cover 60 such that the outer terminals 62 may be exposed.

As described above, according to an embodiment, the protective circuit module 60 may be insertedly installed into the seating groove 46 of the cap plate 40, thereby making it possible to stably protect the protective circuit module 60 from external impact.

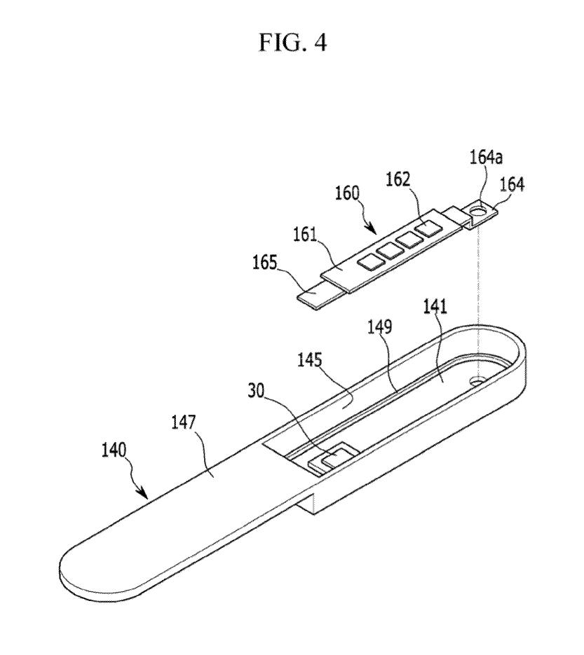

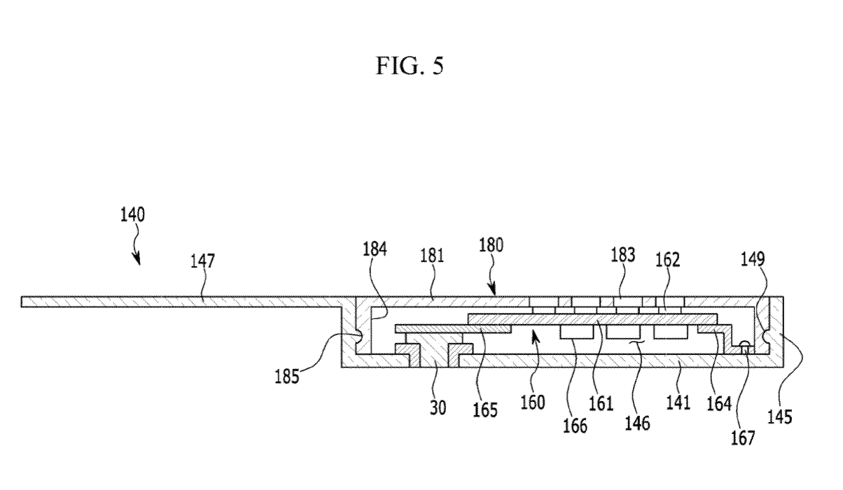

FIG. 4 illustrates an exploded perspective view of a cap plate and a protective circuit module according to an embodiment, and FIG. 5 illustrates a cross-sectional view of a state in which members shown in FIG. 4 are coupled with each other.

Referring to FIG. 4 and FIG. 5, the rechargeable battery according to the present embodiment may have the same general configuration as the rechargeable battery according to the previous embodiment, except for the structure of a cap plate 140, a protective circuit module 160, and a top cover 180. Therefore, a repeated detailed description thereof may be omitted.

The cap plate 140 may be coupled with the receiving case at the opening 20a of the receiving case 20 to seal the receiving case 20. The cap plate 140 may be made of, e.g., an electrically conductive metal material such as aluminum or an aluminum alloy. An inner terminal 30 may be electrically connected to the negative electrode and may be insertedly installed into or onto the cap plate 140.

The cap plate 140 may include an upper plate 147, a base 141 (below or offset lower than the upper plate 147), and a sidewall 145 (protruding upwardly from a side end of the base 141). The upper plate 147 may extend in a lengthwise direction of the cap plate 140, and may be connected to or coupled with the sidewall 145 (e.g., adjacent to one end of the base 141). The base 141 may extend toward or in parallel with the upper plate 147 from one side end in the lengthwise direction of the cap plate 140, and may be connected to or coupled with the upper plate 147 via the sidewall 145.

A seating groove 146 may be formed or bounded by the base 141 and the sidewall 145. For example, the seating groove 146 may extend from the one side end of the cap plate 140 to the upper plate 147.

The protective circuit module 160 (that controls the charging and discharging operations of the rechargeable battery) may be insertedly installed into the seating groove 146. The protective circuit module 160 may include a substrate 161 and a plurality of circuit elements 166 mounted on the substrate 161. In an implementation, the protective circuit module 160 may include a lead tab 164 attached to the cap plate 140. In an implementation, the lead tab 164 may include a screw hole 164a into which a screw is inserted. The lead tab 164 may be fixed to the base 141 by the screw and may be electrically connected to the base 141. In an implementation, a terminal tab 165 (fixed to the inner terminal 30) may be installed in or on the protective circuit module 160, and the terminal tab 165 may be fixed to the inner terminal 30 by welding.

In an implementation, outer terminals 162, e.g., four outer terminals 162, may be installed in or on the protective circuit module 160. For example, the outer terminals 162 may serve as a sensing terminal capable of transferring the current to the outside and measuring the current and the voltage of the rechargeable battery.

The top cover 180 may be insertedly installed into or onto the seating groove 146, and may also cover the protective circuit module 160. The top cover 180 may include a supporting plate 181 and a supporting wall 184. The supporting wall 184 may protrude downwardly, e.g., orthogonally, from a side end of the supporting plate 181. Fixing grooves 185 may be formed in the supporting wall 184 and may be fitted or coupled with fixing protrusions 149 protruding from the sidewall 145. A plurality of terminal holes 183 may be formed in the top cover 60 so that the outer terminals 162 may be exposed.

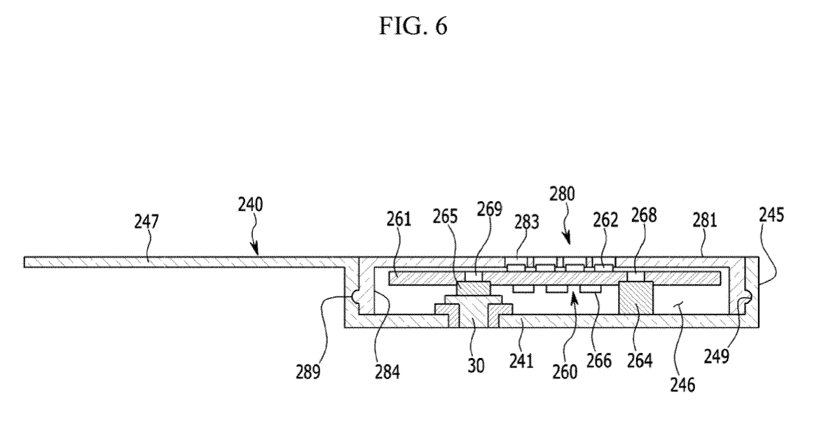

FIG. 6 illustrates a cross-sectional view of a portion of a rechargeable battery according to an embodiment.

Referring to FIG. 6, the rechargeable battery according to the present embodiment may have the same general configuration as those of the rechargeable battery according to the previous embodiments, except for the structures of a cap plate 240, a protective circuit module 260, and a top cover 280. Therefore, a repeated detailed description thereof may be omitted.

The cap plate 240 may be coupled with the receiving case 20 at the opening 20a of the receiving case 20 to seal the receiving case 20. The cap plate 240 may be made of, e.g., an electrically conductive metal material such as aluminum or an aluminum alloy. An inner terminal 30 may be electrically connected to a negative electrode and may be insertedly installed into the cap plate 240.

The cap plate 240 may include an upper plate 247, a base 241 (below or offset lower than the upper plate 247), and a sidewall 245 (protruding upwardly from a side end of the base 241). The upper plate 247 may extend in a lengthwise direction of the cap plate 240, and may be connected to the sidewall 245. The base 241 may extend toward or in parallel with the upper plate 247 from one side end in the lengthwise direction of the cap plate 240, and may be connected to or coupled with the upper plate 247 via the sidewall 245.

A seating groove 246 may be formed or bounded by the base 241 and the sidewall 245. The seating groove 246 may extend from the one side end of the cap plate 240 to the upper plate 247.

The protective circuit module 260 (that controls the charging and discharging operations of the rechargeable battery) may be insertedly installed into the seating groove 246. The protective circuit module 260 may include a substrate 261 and a plurality of circuit elements 266 mounted on the substrate 261. In an implementation, the protective circuit module 260 may include a connection protrusion 264 (welded to the cap plate 240) and a terminal connection member 265 (welded to the inner terminal 30).

The connection protrusion 264 may protrude toward the base 241 from a lower portion of the substrate 261 and may be fixed to the base 241 by, e.g., welding. The substrate 261 may be provided with an opening 268 on an upper portion of or overlying the connection protrusion 264 to expose the connection protrusion 264. Thus, a weld member may be inserted into the opening 268 and then, the connection protrusion 264 may be fixed to the cap plate 240 by, e.g., ultrasonic welding or resistance welding.

The terminal connection member 265 may protrude toward the inner terminal 30 from a lower portion of the substrate 261 and may be fixed to the inner terminal 30 by, e.g., welding. The substrate 261 may be provided with an opening 269 that is formed on an upper portion of or overlying the terminal connection member 265 to expose the terminal connection member 265. Accordingly, the terminal connection member 265 may be fixed to the inner terminal 30 by, e.g., inserting the welding member into the opening 269.

In an implementation, outer terminals 262, e.g., four outer terminals 262, may be installed in or on the protective circuit module 30. For example, the outer terminals 262 may serve as a sensing terminal for transferring current to the outside and measuring the current and the voltage of the rechargeable battery.

The top cover 280 may be insertedly installed into or on the seating groove 246, and/or may cover the protective circuit module 260. The top cover 280 may include a supporting plate 281 and a supporting wall 284 (that protrudes downwardly from a side end of the supporting plate 281, e.g., orthogonally and/or inwardly in the battery. Fixing protrusions 289 may be provided on the supporting wall 284 and may be fitted into fixing grooves 249 provided in the sidewall 245. A plurality of terminal holes 283 may be provided in the top cover 60 so that the outer terminals 262 may be exposed.

By way of summation and review, a rechargeable battery may include a protective circuit module that controls current and voltage. The protective circuit module may be on a cap plate, and may be vulnerable to external impact, e.g., the protective circuit module may be damaged when the external impact is applied from the outside.

In addition, when the protective circuit module is in the case, in order to protect the protective circuit module from the electrolyte solution, a sealing structure may be additionally formed.

The embodiments may provide a rechargeable battery in which a protective circuit module is stably installed.

According to an embodiment, the protective circuit module may be insertedly disposed in the groove formed on the cap plate, thereby making it possible to stably protect the protective circuit module.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

<Description of symbols>

| | |
|---|---|
| 101: Rechargeable battery | 10: Electrode assembly |
| 11: Positive electrode | 12: Negative electrode |
| 13: Separator | 16: Positive electrode tab |
| 17: Negative electrode tab | 20: Receiving case |
| 20a: Opening | 21: Step groove |
| 25, 185, 249: Fixing groove | 30: Inner terminal |
| 35: Insulation gasket | 40, 140, 240: Cap plate |
| 41, 141, 241: Base | 42: Electrolyte solution |
| | injection hole |
| 43: Cap | 45, 145, 245: Sidewall |
| 48: Terminal hole | 46, 146, 246: Seat groove |
| 51: Insulation plate | 51a: Terminal hole |
| 52: Connection plate | 52a: Hole |
| 60, 160, 260: Protective circuit | 61, 161, 261: Substrate |
| module | |
| 62, 162, 262: Outer terminal | 63, 265: Terminal connection |
| | member |
| 64, 65, 164: Lead tab | 65, 166, 266: Circuit element |
| 67: Aperture | 70: Insulation case |
| 71: Bottom | 72: Supporting rib |
| 73: First tab hole | 74: Second tab hole |
| 80, 180, 280: Top cover | 81, 183, 283: Terminal hole |
| 83, 181, 281: Supporting plate | 83: Supporting plate |
| 84, 184, 284: Supporting wall | 85, 149: Fixing protrusion |
| 167, 267: Upper plate | |

What is claimed is:

1. A rechargeable battery, comprising:
an electrode assembly, the electrode assembly including a first electrode, a second electrode, and a separator interposed therebetween;
a receiving case having a space in which the electrode assembly is accommodated;
a cap plate coupled with the receiving case, the cap plate having a seating groove therein; and
a protective circuit module in the seating groove,
wherein the cap plate includes a base and a sidewall, the sidewall protruding from a side end of the base to form the seating groove.

2. The rechargeable battery as claimed in claim 1, wherein the receiving case includes a step groove therein, the sidewall of the cap plate being in the step groove.

3. The rechargeable battery as claimed in claim 1, wherein the protective circuit module further includes a connection tab fixed to the base of the cap plate.

4. The rechargeable battery as claimed in claim 3, wherein the connection tab is fixed to the base by welding.

5. The rechargeable battery as claimed in claim 3, wherein the connection tab is fixed to the base by a screw.

6. The rechargeable battery as claimed in claim 1, wherein the cap plate further includes an upper plate, the upper plate contacting an upper end of the sidewall and extending in a lengthwise direction of the cap plate.

7. The rechargeable battery as claimed in claim 6, wherein one end of the base in the lengthwise direction of the cap plate and one end of the upper plate in the lengthwise direction of the cap plate are connected to each other via the sidewall.

8. The rechargeable battery as claimed in claim 1, wherein:
the protective circuit module includes a connection protrusion, the connection protrusion protruding toward the base,
an upper portion of the protective circuit module includes an aperture therein, and
the connection protrusion is fixed to the cap plate by welding through the aperture.

9. The rechargeable battery as claimed in claim 1, wherein the protective circuit module includes a plurality of outer terminals thereon.

10. The rechargeable battery as claimed in claim 1, further comprising a top cover, the top cover covering the protective circuit module and being coupled with the receiving case.

11. The rechargeable battery as claimed in claim 10, wherein:
the top cover includes fixing protrusions thereon, and
an outer surface of the receiving case includes fixing grooves therein, the fixing protrusions being coupled with the fixing grooves.

12. The rechargeable battery as claimed in claim 1, further comprising a top cover, the top cover covering the protective circuit module and being fitted into the seating groove.

13. The rechargeable battery as claimed in claim 12, wherein:
the sidewall of the cap plate includes fixing protrusions thereon, and
the top cover includes fixing grooves therein, the fixing protrusions being coupled with the fixing grooves.

14. The rechargeable battery as claimed in claim 12, wherein:
the sidewall of the cap plate includes fixing grooves therein, and
the top cover includes fixing protrusions thereon, the fixing protrusions being coupled with the fixing grooves.

15. The rechargeable battery as claimed in claim 1, further comprising an insulation case between the electrode assembly and the cap plate.
